(19) United States
(12) Patent Application Publication
(10) Pub. No.: US 2012/0325799 A1
(43) Pub. Date: Dec. 27, 2012

(54) Electric Hot Plate

(75) Inventor: Chih-Hsiu Liu, New Taipei City (TW)

(73) Assignee: NENG BAO KANG ENTERPRISE CORPORATION, New Taipei City (TW)

(21) Appl. No.: 13/406,265

(22) Filed: Feb. 27, 2012

(30) Foreign Application Priority Data
Jun. 24, 2011 (TW) 100122348

(51) Int. Cl. H05B 3/68

(52) U.S. Cl. 219/452.11; 219/453.11; 219/457.1; 219/455.11

(57) ABSTRACT

An electric hot plate includes an electric roasting portion and a fume extraction portion coupled by a support rod, and the electric roasting portion includes a base, a control system installed on the base and coupled to an upper heating plate; and the fume extraction portion includes a plurality of fume extraction fans installed on a fume cover and coupled to the control system, and an oil filter portion. The electric hot plate features low power consumption and low electromagnetic radiation and can timely extract the fume produced in the roasting process to reduce the production of harmful toxic matters and protect the users' health, and the electric hot plate of the invention is applicable for indoor and outdoor usage including the use at home or in barbeque restaurants.

### CROSS-REFERENCE TO RELATED APPLICATION

This application claims the benefit of Taiwan Patent Application No. 100122348, filed on Jun. 24, 2011, in the Taiwan Intellectual Property Office, the disclosure of which is incorporated herein in its entirety by reference.

### BACKGROUND OF THE INVENTION

1. Field of the Invention

The present invention relates to an electric hot plate.

2. Description of the Related Art

Most conventional electric hot plates come with aluminum extruded heat pipes, thus resulting in uneven heating, high-power consumption, and high-power electromagnetic waves. Although some electric hot plates are coated with a nano coating and most of the coatings are made of Teflon, the Teflon coating may be damaged easily to produce toxic matters during a washing process after the electric hot plates are used. Existing electric hotplates are only for indoor usage and the oil fumes produced during a roasting process causes serious pollution to the indoor decoration that is hard to clean.

### SUMMARY OF THE INVENTION

In view of the aforementioned problem of the conventional electric hot plate, it is a primary objective of the present invention to provide an electric hot plate to overcome the problem of the prior art.

To achieve the foregoing objective, the present invention provides an electric hot plate comprising an electric roasting portion and a fume extraction portion coupled by a support rod; wherein the electric roasting portion includes a base, and a control system is installed on the base and coupled to an upper heating plate; the fume extraction portion includes a plurality of fume extraction fans installed on a fume cover and coupled to the control system, and an oil filter portion.

The present invention is further characterized in that the base further includes an upper hot plate casing and a lower hot plate casing fixed to the base, and the upper hot plate casing is coupled to the upper heating plate by a lower heating plate; the lower hot plate casing includes the control system, and the control system includes a knob switch, a power switch, a thermostat switch, a plurality of heat dissipating fans and a micro switch installed on the lower hot plate casing and coupled to the control system, and the thermostat switch is in contact with the lower heating plate, and the lower hot plate casing has a plurality of heat dissipating holes matched with the heat dissipating fan.

The present invention is further characterized in that the oil filter portion including a filter, an activated carbon filter and a fume extraction filter, and the fume extraction fan is fixed onto the fume cover by a fume extractor body, and the fume extractor body is sequentially coupled to the filter, the activated carbon filter, and the fume extraction filter.

The present invention is further characterized in that the support rod includes a contact point formed at both ends of the support rod separately and provided for connecting the contact points of the lower hot plate casing and the fume cover respectively.

The present invention is further characterized in that an oil blocking plate is coupled to an oil pan by an oil blocking groove to form an integral part.

The present invention is further characterized in that the fume cover includes an accessory box, an accessory box cover matched with the accessory box and a cover plate.

The present invention is further characterized in that the electric hot plate is fixed on a high foot pad portion; the high foot pad portion includes a heightened rod, a support pipe connector coupled to the heightened rod and a foot pad; the heightened rod is coupled to the lower hot plate casing by the support pipe connector.

The present invention is further characterized in that the electric hot plate is fixed onto a low foot pad portion; the low foot pad portion includes a foot pad base and a foot pad; and the foot pad base is coupled to the lower hot plate casing.

The present invention is further characterized in that the electric hot plate is made of crystallite glass or ceramic.

With the aforementioned technical measures, an electric hot plate of the present invention features low power consumption. The power consumption of a conventional electric oven falls within a range of 1200-2000 W, and the power consumption of electric hot plate of the present invention falls within a range of 600-800 W only. In addition, the present invention has less electromagnetic radiation (25 mGy) than the electromagnetic radiation (200 mGy) of the conventional electric oven; the present invention can timely extract the fume produced in the roasting process and let the fume being absorbed by the filter to reduce the production of harmful toxic matters to protect the users' health, and the electric hot plate of the present invention is applicable for indoor and outdoor usage including the usage at home or in barbeque restaurants.

### BRIEF DESCRIPTION OF THE DRAWINGS

FIG. 1 is a schematic view of an electric hot plate in accordance with a first preferred embodiment of the present invention;

FIG. 2 is a schematic view of an electric hot plate in accordance with a second preferred embodiment of the present invention;

FIG. 3 is an exploded view of an electric hot plate of FIG. 1;

FIG. 4 is a schematic view of an electric hot plate with a fume extraction portion of FIG. 1;

FIG. 5 is a schematic view of an electric hot plate with an electric heating portion of FIG. 1;

FIG. 6 is a schematic view of a support rod portion of FIG. 1;

FIG. 7 is a schematic view of a high foot pad portion of FIG. 1; and

FIG. 8 is a schematic view of a low foot pad portion of FIG. 2.

### DETAILED DESCRIPTION OF THE PREFERRED EMBODIMENTS

The technical characteristics of the present invention will become clear with the detailed description of the preferred embodiments accompanied with the illustration of related drawings as follows.

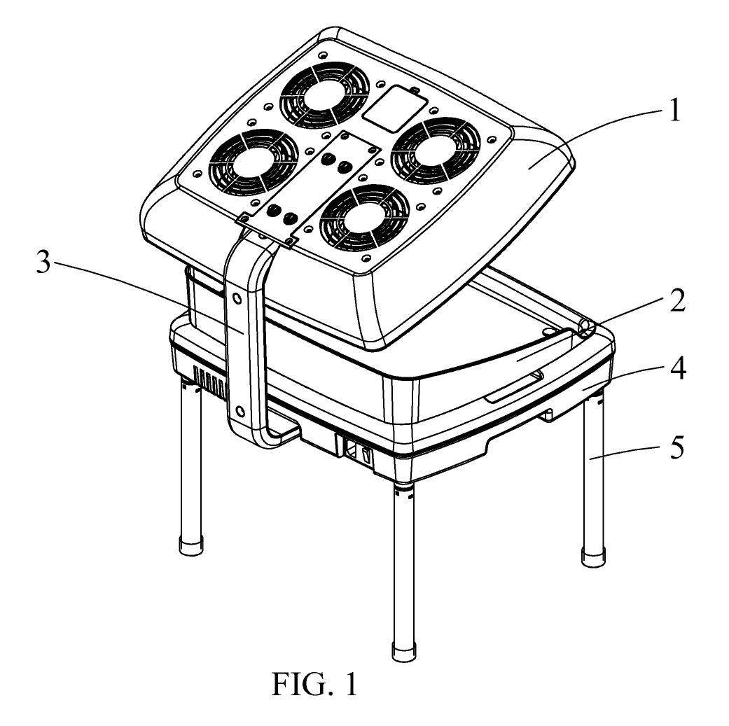

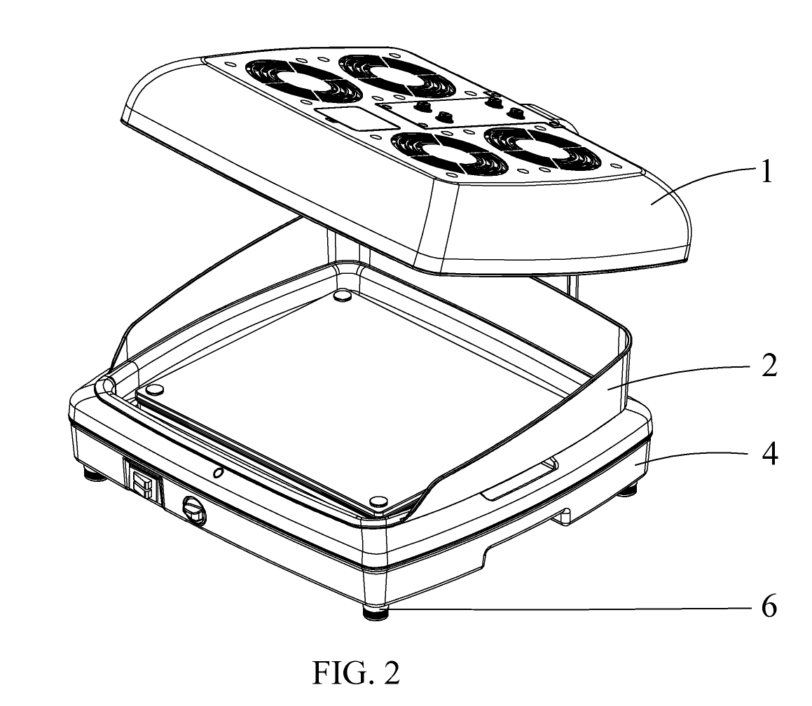

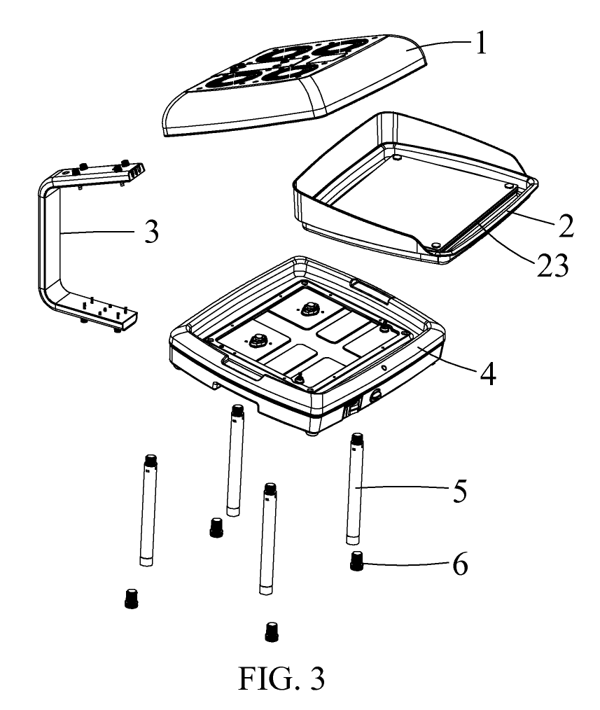

With reference to FIGS. 1 to 3 for an electric hot plate of the present invention, the electric hot plate comprises an electric roasting portion 4 and a fume extraction portion 1 coupled by a support rod portion 3, and the electric roasting portion 4 is fixed on four high foot pad portion 5 or four low foot pad portion 6. The electric roasting portion 4 is provided for roasting food, and the support rod portion 3 is coupled to the fume extraction portion 1 for absorbing oil fumes produced during a roasting process to prevent too much oil fumes produced from an indoor usage and prevent jeopardizing our health. The electric roasting portion 4 includes a control system for controlling the operating status of the fume extraction portion 1 and the electric roasting portion 4.

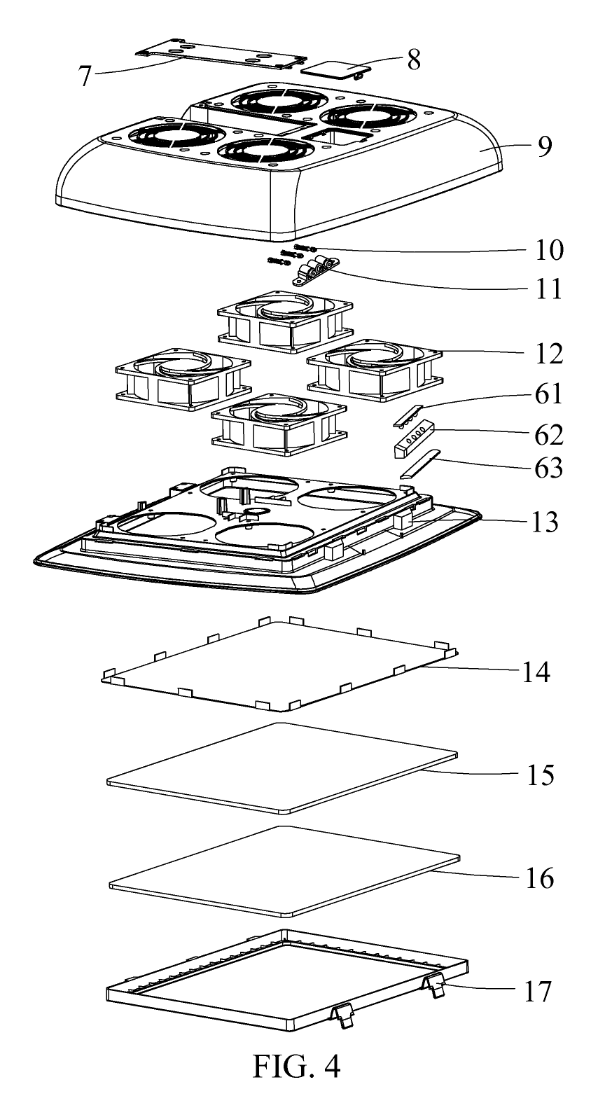

With reference to FIG. 4 for a schematic view of a fume extraction portion of an electric hot plate in accordance with the present invention, the fume extraction portion 1 includes a plurality of fume extraction fans 12 installed on a fume cover 9 and coupled to the control system, and an oil filter portion. The oil filter portion including a filter, an activated carbon filter and a fume extraction. A fume extraction fan 12 fixed on a side of the fume extractor body 13, and a filter 14 fixed to the other side of the fume extractor body 13, wherein the filter frame 17 is provided for fixing the activated carbon filter 15 and the oil fume filter 16 on the filter 14, and the filter frame 17 is snapped onto the fume extractor body 13 to facilitate its removal. If the activated carbon filter 15 and the fume extraction filter 16 have absorbed too much extracted oils, the filter frame 17 can be removed to change the filter timely. The fume cover 9 is fixed with the screw fixing frame 11 on the fume extractor body 13 through the contact screw 10. The fume extraction fan 12 is coupled to the control system. In this preferred embodiment, there are four fume extraction fans 12, and they are fans of 12 V working in DC (direct current) with the features of strong wind, low noise and long working lifetime. The fume extractor body 13 includes an illumination lamp 61 installed thereon and coupled to the control system, and the illumination lamp 61 is coupled to a lampshade 63, and the illumination lamp 61 has a reflector 62 installed under the lampshade 63 and provided for reflecting and collecting light to allow user to see the operating status of the electric hot plate clearly to facilitate the operation.

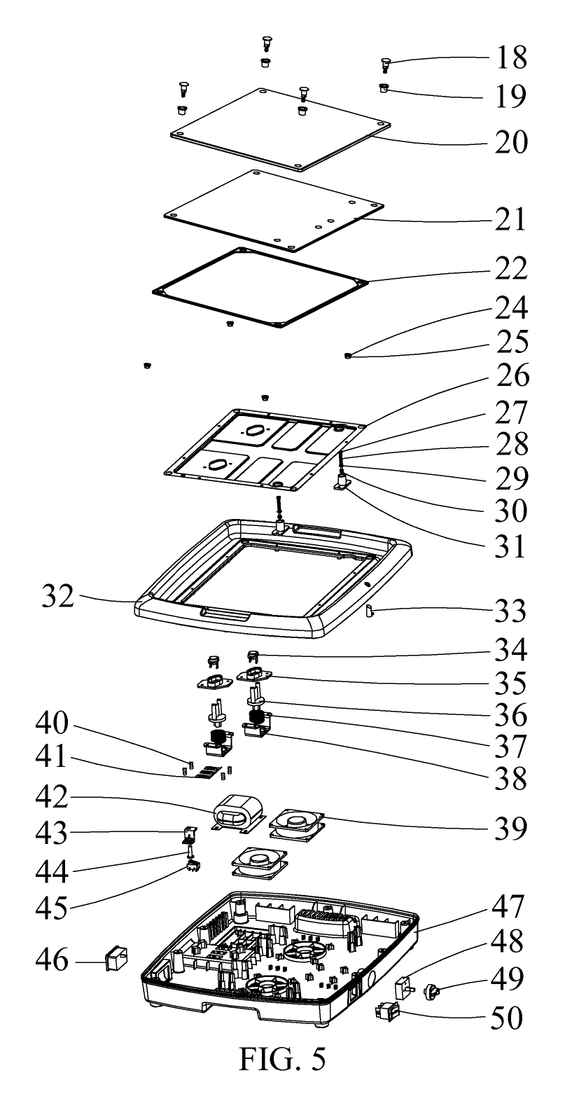

With reference to FIG. 5 for a schematic view of an electric roasting portion, the electric roasting portion 4 comprises a base, and the base is fixed to the upper hot plate casing 32 and the lower hot plate casing 47, and the lower hot plate casing 47 includes a control system installed thereon, and the control system is coupled to the knob switch 48, power switch 46, thermostat switch 34 and a micro switch 45 of the lower hot plate casing 47; the control system coupled to a lower heating plate 21 and provided for controlling whether to heat the lower heating plate 21 during a roasting process. The upper hot plate casing 32 is fixed to an iron plate 26 of the electric hot plate, and the lower heating plate 21 and the upper heating plate 20 fixed together with each other are coupled on the top of the iron plate 26 of the electric hot plate, and the upper hot plate casing 32 is provided for a position limiting purpose to prevent them from sliding or moving with respect to the upper hot plate casing 32.

The lower hot plate casing 47 includes a contact fixing frame 31, and a contact screw 27 fixes a spring 28 onto the contact fixing frame 31, and the contact screw 27 is sheathed with a nut 30 and a pad 29. The control system is coupled to the iron plate 26 of the electric hot plate through the contact screw 27 on the lower hot plate casing 47. In this preferred embodiment, there are two thermostat switches 34, and the thermostat switches 34 are in contact with the lower heating plate 21, and the lower hot plate casing 47 includes a thermostat fixing frame 38 coupled to a thermostat directing frame 35. A thermostat support stand 36 is contained between the thermostat fixing frame 38 and the thermostat directing frame 35, and a spring 37 is installed between a lower end of the thermostat support stand 36 and the thermostat fixing frame 38. The spring 37 is provided for popping up the thermostat switch 34, such that the thermostat switch 34 is in contact with the lower heating plate 21 thought the iron plate 26 of the electric hot plate, and the temperature of the lower heating plate 21 can be sensed. The micro switch 45 is fixed to the lower hot plate casing 47 through the micro switch fixing frame 43, and the micro switch fixing frame 43 fixes a copper contact plate 41 and a press rod 44 through a nut 40; the copper contact plate 41 can be passed through the iron plate 26 of the electric hot plate with the support by the press rod 44. The lower heating plate 21 and the upper heating plate 20 can be integrated by a positioning screw 18, and the positioning screw 18 is sheathed with a silicone screw 19 to prevent food from being contaminated by the positioning screw 18 during the roasting process. When the integrally fixed upper heating plate 20 and lower heating plate 21 are removed, the power of the electric hot plate will be disconnected automatically by the micro switch 45 to prevent accidents.

In this preferred embodiment, there are two power switches 46, one for controlling the power input of the electric hot plate and the other one for turning on or off the fume extraction fan 12. After the electric hot plate is turned on, the knob switch 48 is used for adjusting and controlling the temperature of the electric hot plate. In this preferred embodiment, there are two shifts of the knob switch 48, one for setting the temperature to 200 and the other for setting the temperature to 250. The lower hot plate casing 47 includes a plurality of heat dissipating fans 39 and a plurality of heat dissipating holes matched with the heat dissipating fan 39, and the heat dissipating fan 39 is coupled to the control system. The heat dissipating fan 39 is a fan of 12 V working in DC, and the control system includes a transformer 42 for converting external alternate current to an appropriate voltage, such that the heat dissipating fan 39 can dissipate the heat of the control system effectively.

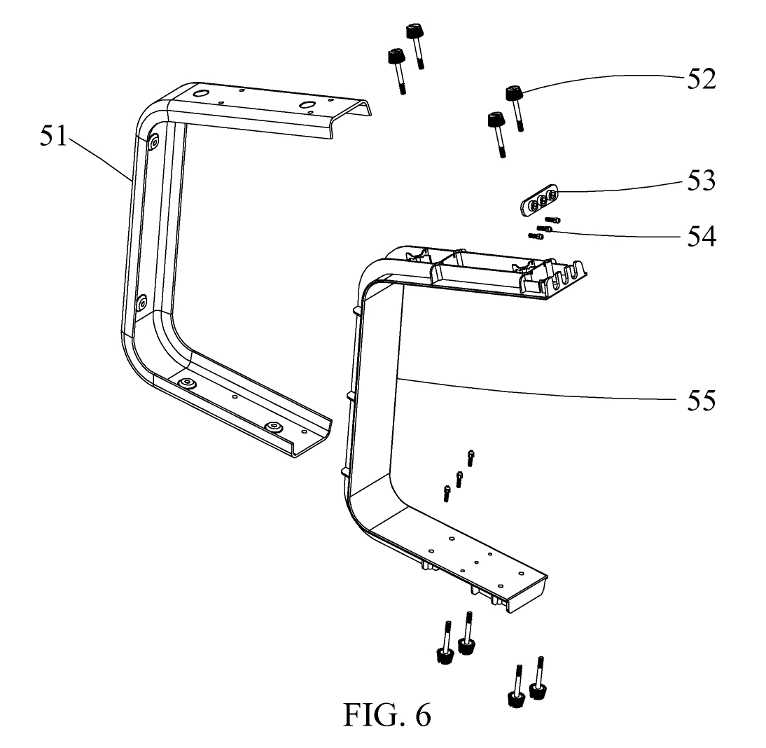

With reference to FIG. 6 for a schematic view of a support rod of the present invention. An end of the support rod portion 3 is fixed onto the fume cover 9 by a quick lock screw 52, and the other end of the support rod portion 3 is fixed onto the lower hot plate casing 47 by a quick lock screw 52. Both ends of the support rod portion 3 have contact points coupled to the contact points on the lower hot plate casing 47 and the fume cover 9, such that the fume extraction fan 12 and the control system could form a circuit. When a user uses the electric hot plate outdoors, the fume extraction portion 1 can be removed. When the user uses the electric hot plate indoors, the fume extraction portion 1 can be re-installed. The user can assemble the fume extraction portion 1 quickly by means of the quick lock screw 52. After the assembling process is finished, both ends of the support rod portion 3 can be coupled to the contact points on the lower hot plate casing 47 and the fume cover 9 by the contact points of the support rod portion 3, such that the fume extraction fans 12 and the control system form a circuit again. A power contact shield 53 is fixed to the support rod 55, and the power contact shield 53 includes a power contact point 54 provided for conducting current.

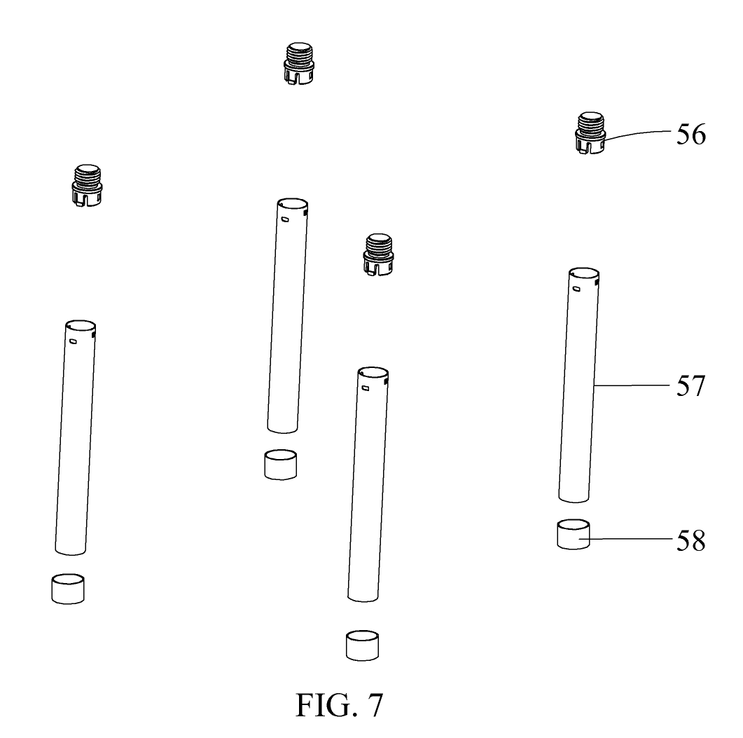

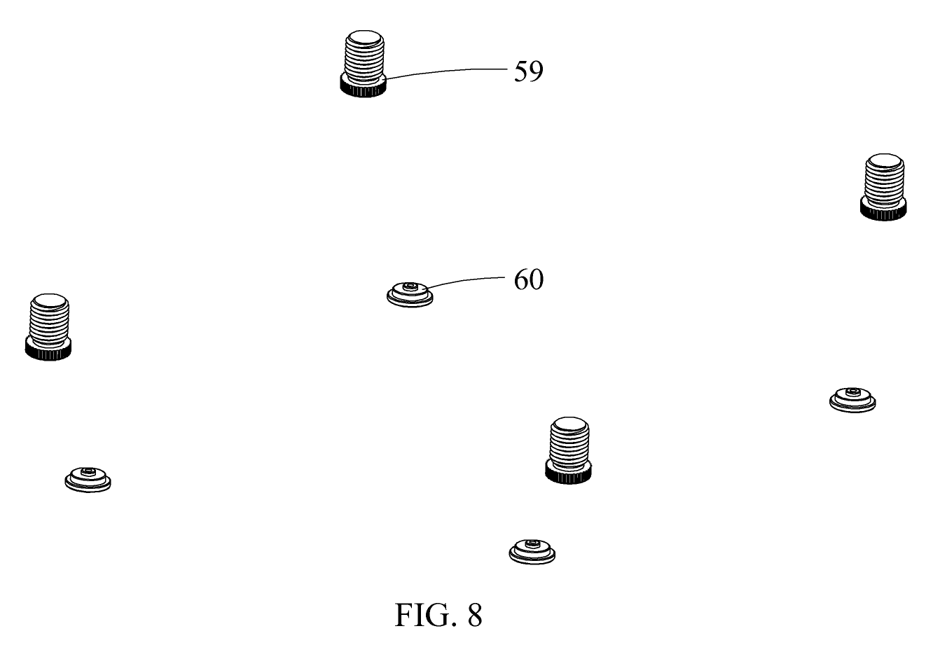

With reference to FIGS. 7 and 8 for schematic views of heightened portions of the present invention. Two kinds of heightened portions including a high foot pad portion 5 and a low foot pad portion 6 are provided in present invention. In the schematic view of the high foot pad portion 5 of the present invention as shown in FIG. 7, the high foot pad portion 5 is used for a greater required height, wherein the high foot pad portion 5 comprises a heightened rod 57 with a support pipe joint 56 and a silicone foot pad 58 coupled to the heightened rod 57, and the heightened rod 57 is coupled to the lower hot plate casing 47. In the schematic view of the low foot pad portion 6 of the present invention as shown in FIG. 8, the low foot pad portion 6 is used for a lesser required height, and the low foot pad portion 6 includes a foot pad base 59 and a foot pad 60 coupled to the foot pad base 59, and the foot pad base 59 is coupled to the lower hot plate casing 47.

The upper heating plate 20 and the lower heating plate 21 can be removed from the upper hot plate casing 32 to facilitate their cleaning and storage. The integrally formed upper heating plate 20 and lower heating plate 21 can fix an oil blocking plate 2 to the upper hot plate casing 32. The oil blocking plate 2 is coupled to an oil pan (not shown in the figure) by an oil blocking groove 23 arranged in the bottom of the oil blocking plate 2. The oil pan is provided for storing waste oils or food waste produced during the roasting process and the oil blocking plate 2 can block the oil produced in the roasting process and prevent the oil from splashing. The control system adopts a power switch controlled by an independent dual temperature controlled control system to assure an accurate cooking temperature, so as to prevent food from being charred by a too-high temperature.

The electric hot plate can be designed with a power of 48 V and connected externally to a power supply from a car battery to satisfy the power supply requirements for the outdoor usage. In addition, the upper heating plate 20 of the present invention is made of ceramic or crystallite glass, and the heat generating material is coated onto the backside of the heating plate to reduce electromagnetic radiation and power consumption. If ceramic is chosen, ceramic can release infrared beams to provide the barbeque taste. The fume cover 9 includes an accessory box and an accessory box cover 8 and a cover plate 7 matched with the accessory box. The accessory box can be used for storing the screws. The whole electric hot plate can be disassembled for a convenient transportation requirement, and the detached screws can be placed into the accessory box to prevent them from missing and facilitate users to find the screws for a quick assembling. For the assembling and disassembling, a coin can be used as a tool for such purposes.

While the invention has been described by means of specific embodiments, numerous modifications and variations could be made thereto by those skilled in the art without departing from the scope and spirit of the invention set forth in the claims.

What is claimed is:

1. An electric hot plate, comprising:
an electric roasting portion, including a base, and a control system installed on the base and coupled to an upper heating plate; and
a fume extraction portion coupled to the electric hot plate by a support rod, the fume extraction portion including a plurality of fume extraction fans installed on a fume cover and coupled to the control system, and an oil filter portion.

2. The electric hot plate of any one of claims 1, wherein the electric hot plate is made of a material of crystallite glass or ceramic.

3. The electric hot plate of claim 1, wherein the base further includes an upper hot plate casing and a lower hot plate casing fixed to the base, and the upper hot plate casing is coupled to the upper heating plate by a lower heating plate; the lower hot plate casing includes the control system, and the control system is coupled to a knob switch, a power switch, a thermostat switch, a plurality of heat dissipating fans and a micro switch installed on the lower hot plate casing, and the thermostat switch is in contact with the lower heating plate, and the lower hot plate casing has a plurality of heat dissipating holes matched with the heat dissipating fan.

4. The electric hot plate of any one of claims 3, wherein the electric hot plate is made of a material of crystallite glass or ceramic.

5. The electric hot plate of claim 1, wherein the oil filter portion includes a filter, an activated carbon filter and a fume extraction filter, and the fume extraction fan is fixed onto the fume cover by a fume extractor body, and the fume extractor body is sequentially coupled to the filter, the activated carbon filter, and the fume extraction filter.

6. The electric hot plate of any one of claims 5, wherein the electric hot plate is made of a material of crystallite glass or ceramic.

7. The electric hot plate of claim 5, wherein the support rod includes a contact point formed at both ends of the support rod separately and provided for connecting the contact points of the lower hot plate casing and the fume cover respectively.

8. The electric hot plate of any one of claims 7, wherein the electric hot plate is made of a material of crystallite glass or ceramic.

9. The electric hot plate of claim 7, wherein an oil blocking plate is coupled to an oil pan by an oil blocking groove to form an integral part.

10. The electric hot plate of any one of claims 9, wherein the electric hot plate is made of a material of crystallite glass or ceramic.

11. The electric hot plate of claim 9, wherein the fume cover includes an accessory box, an accessory box cover matched with the accessory box and a cover plate.

12. The electric hot plate of any one of claims 11, wherein the electric hot plate is made of a material of crystallite glass or ceramic.

13. The electric hot plate of claim 11, wherein the electric hot plate is fixed on a high foot pad portion; the high foot pad portion includes a heightened rod, a support pipe connector coupled to the heightened rod and a foot pad; the heightened rod is coupled to the lower hot plate casing by the support pipe connector.

14. The electric hot plate of any one of claims 13, wherein the electric hot plate is made of a material of crystallite glass or ceramic.

15. The electric hot plate of claim 11, wherein the electric hot plate is fixed onto a low foot pad portion; the low foot pad portion includes a foot pad base and a foot pad; and the foot pad base is coupled to the lower hot plate casing.

16. The electric hot plate of any one of claims 15, wherein the electric hot plate is made of a material of crystallite glass or ceramic.
